(19) United States
(12) Patent Application Publication
(10) Pub. No.: US 2005/0172702 A1
(43) Pub. Date: Aug. 11, 2005

(54) Method and apparatus for determining characteristics of thin films and coatings on substrates

(76) Inventors: Norm V. Gitis, Cupertino, CA (US); Michael Vinogradov-Nurenberg, Sunnyvale, CA (US); Jun Xiao, San Jose, CA (US)

Correspondence Address: Norm Gitis, 10131 Firwood Drive, Cupertino, CA, 95014, US

(21) Appl. No.: 10/771,632

(22) Filed: Feb. 5, 2004

(51) Int. Cl. G01N 3/46

(52) U.S. Cl. 73/81; 73/150 R; 702/35

(57) ABSTRACT

A method and apparatus of the invention are intended for determining characteristics of thin films, layers and coatings on under-layers and substrates when the films, layers and coatings have electrical characteristics measurably different from those of the under-layers and substrates. The method consists of selecting an object with an appropriate combination of a coating and substrate having different electrical characteristics, connecting one electrical contact to either the coating when the coating is more conductive than its substrate or to the substrate when the coating is less conductive than its substrate, connecting a second electrical contact to either the coating when the coating is conductive or to a conductive indenter when the coating is non-conductive, causing a relative movement between the indenter and the coating with application of an either constant or increasing force with simultaneous monitoring of electrical characteristics of the aforementioned circuit, until these characteristics change substantially and reach a critical level. The substantial changes in the electrical characteristics correspond to film or coating removal and exposure of the under-layer or substrate to the indenter. The characteristics of the thin films, layers and coatings are evaluated based on either critical load or distance or number of cycles corresponding to the substantial change in the electrical characteristics. The invention also relates to an apparatus for realization of the method.

### FIELD OF INVENTION

The present invention relates to determining characteristics of films and coatings on under-layers or substrates. In particular, the invention relates to a method of testing durability characteristics of the aforementioned films and coatings via micro-scratching the surface of the films and coating by means of an indenter, which may be included into an electric measurement circuit. The invention also relates to the aforementioned tests based on deterioration of the film or coating by impressing an indenter under an applied force. The invention may find use for studying and testing durability and fatigue, wear and scratch resistance, adhesion and delamination resistance of conductive and non-conductive solid surfaces, coatings and films, as well as near-surface layers of various materials, including metals, composites, polymers, ceramics, etc.

### BACKGROUND OF THE INVENTION

The use of coating films, both thin and thick, in various industries is increasing constantly. Thin films are used extensively in such fields as magnetic and electronic materials. For example, a hard disk used in computer disk drives comprises either an aluminum alloy or a glass substrate, coated with a multi-layered structure of various materials, including a nickel-phosphorous layer of several micron thickness, magnetic layer(s) of a fraction of micron thickness, and then a carbon overcoat less than a dozen nanometer thick. Both scratch resistance of the top carbon layer and delamination resistance, or adhesion, of each of the layers are matters of great importance for the drive durability.

Another example of thin film application is microelectronics, where thin films deposited onto a silicon substrate and treated with photolithography and etching are formed into well defined fine lines used as conductive interconnects between elements of semiconductor chips. In this case, the durability of the microelectronic devices depends on the delamination resistance, or adhesion, of thin films to their under-layers or substrates.

An example of a thick coating is paint on various surfaces of automotive vehicles. The paint has to be scratch resistant, at the same time having good delamination resistance, or adhesion, to its metal or non-metal substrate. When paint includes two or three layers, for example an under-layer, color layer and transparent overcoat, the delamination resistance of each of the layers is an important characteristic of the durability. Another example is a coating on optical lenses, which may include anti-reflective and wear-resistant layers; the lens durability is defined by both scratch resistance of the surface and delamination resistance, or adhesion strength, of each of the coated layers.

Thus, there has been continued development in the art to evaluate characteristics of the films and coatings on substrates.

To clarify the terminology used in the description of the present invention, it should be noted that the term “durability” designates a certain integrated characteristic of an object that normally includes the cohesion strength of the material of the film/coating, adhesion strength of the coating/film to a substrate, scratch-resistance, wear-resistance, etc. Hereinafter, the term “durability” will be replaced by the more general term “characteristics” of the films and coatings.

A typical test, which finds wide application for measuring the above characteristics, is known as a micro-scratch test. The micro-scratch test can be used for all kinds of industrial coatings from thin films in semiconductor and optical industries to decorative and protective coatings of consumer goods. The microscratch test consists in that a scratching indenter, typically either a steel or diamond conical tip or stylus, is pressed into the tested material under an applied constant or progressively increasing force, and a relative motion is caused between the indenter and the tested surface, while evaluating the aforementioned characteristics by monitoring friction and acoustic signals.

Known in the art is a micro-scratch tester of CSM Instruments, distributed by Micro Photonics, Irvine, Calif., USA. The technique involves generating a controlled scratch with a conical point indenter, either a Rockwell C diamond tip or a sharp steel tip, drawn across a coated surface under either a constant or a progressively increasing force. When the coating starts to fail, the corresponding critical load is detected by means of an acoustic sensor attached to an indenter holder, friction force between the indenter and the surface, penetration depth, and by optical microscopy. The critical load is used to quantify the scratch resistance and adhesion properties of film-substrate combinations.

A disadvantage of such point tips is that the end of the indenter is very sharp, so when the tip is pressed into the tested coating, it develops a very high contact pressure, and even when it does not break through the coating yet, it produces significant stress deep in the substrate. So, the test results are affected by the properties of the substrate, which makes it impossible to accurately measure the properties of thin films and coatings.

U.S. Pat. No. 6,502,455 issued to Gitis, et al. on Jan. 7, 2003 and U.S. Pat. No. 5,696,327 issued to He Huang, et al, on Dec. 9, 1997 describe a micro-scratch test conducted with a blade-type indenter. The blade-type indenter is used to facilitate calculation of the adhesion work of delamination in a two-dimensional representation, as compared to the uni-dimensional representation in the point microscratch test. The test is carried out by pressing the indenter onto a coating and moving either blade or the test sample in relation to each other, with simultaneous application of both normal and lateral forces to the indenter.

In the known scratch test methods, except for the one described in the aforementioned U.S. Pat. No. 6,502,455, only friction and acoustic measurements were combined together, whereas another known test method with measurements of electrical properties (impedance, resistance, capacitance) may be carried out separately, in combination with vertical indentation test, particularly because of non-conductivity of the diamond tips used for microscratch testing. As a result, for many materials the exact determination of the critical load was difficult or impossible, especially in cases of ultra-thin or multi-layered coatings. Although the above problems are partially solved in U.S. Pat. No. 6,502,455, which allows for simultaneous precision acoustic, electrical and mechanical measurements of the indenter-coating interactions, and thus for precision determination of the critical load of, or time till, coating failure, with improved measurement data correlation, none of the aforementioned known methods can provide reliable determination of characteristics in films having surface roughness of the same order as the thickness of the film being tested. In other words, if the coating or film is thick and continuous, determination of the moment when the actual scratching begins presents no problem. However, the above methods become ineffective if the film has a thickness on the order of tens of nanometers or several nanometers, when it may be non-continuous, and the scratch or indentation marks in it are undistinguishable. The statistical value of the discontinuity defects increases with decrease in the film thickness. In other words, if the contact surface of the indenter's tip is the same or smaller than an uncoated area, interpretation of the test results becomes unreliable.

### OBJECTS AND SUMMARY OF THE INVENTION

The object of the present invention is to provide a durability test method and test apparatus for reliable testing and measurement of characteristics in thin and ultra-thin films and coatings on substrates and under-layers. Another object is to provide the aforementioned method and apparatus that allow for reliable interpretation of test and measurement data. Still another object is to provide the aforementioned method and apparatus for measuring characteristics of films and coatings having a thickness of the order of nanometers to tens of nanometers. A further object is to provide the aforementioned method and apparatus that are based on electrical measurements. Still another object is to provide an apparatus suitable for measuring characteristics of both conductive and non-conductive coatings.

The method of the invention covers two embodiments: 1) testing and measuring conductive coatings or films on non-conductive substrates or on substrates having electrical conductivity measurably lower than that of the coatings or films; 2) testing and measuring non-conductive coatings or films on conductive substrates or substrates having electrical conductivity measurably higher than that of the coatings or films. For the simplicity of the description, these combinations are referred to hereafter as combinations of conductive coatings on non-conductive substrates and non-conductive coatings on conductive substrates, correspondingly.

The first method consists of: providing a test apparatus with an indenter, loading unit, means for providing relative movement, means for forming an electrical circuit, and means for measuring electrical characteristics; selecting a combination of a conductive coating with a non-conductive substrate; connecting two electrical contacts to the conductive coating; initiating scratching or indenting or reciprocating relative motion under an applied force across the coating or film in the direction that intersects an imaginary line that connects the two electrical contacts; carrying out this motion and loading simultaneously with measuring electrical characteristics of the conductive film or coating; detecting the moment when the electrical characteristics change substantially (circuit is interrupted and conductivity drops, resistance increases) due to removal of the conductive film or coating, and determining durability characteristics of the coating by analyzing the electrical characteristics versus time or distance or force or number of cycles.

The second method consists of: providing a test apparatus with a conductive indenter, loading unit, means for providing relative movement, means for forming an electrical circuit, and means for measuring electrical characteristics; selecting a combination of a non-conductive coating with a conductive substrate; connecting a first electrical contact to the conductive substrate and a second electrical contact to the conductive indenter; initiating scratching or indenting or reciprocating relative motion under an applied force across the coating or film; carrying out this motion and loading simultaneously with measuring electrical characteristics of the conductive film or coating; detecting the moment when the electrical characteristics change substantially (conductivity increases, resistance drops) due to removal of the non-conductive film or coating, and determining durability characteristics of the coating by analyzing the electrical characteristics versus time or distance or force or number of cycles.

Within the present invention, scratching can be replaced by indentation, reciprocation and other test motions.

The object may comprise a coating or a film or a layer on an undercoat or under-layer or substrate. The aforementioned coating or film or layer may be applied onto the undercoat or under-layer or substrate by different methods, such as chemical vapor deposition, physical vapor deposition, sputtering, plating, etc. Although in the subsequent patent claims only the term “coating” will be used, it should not be construed as limiting the scope of the invention and may cover such terms as “thin film”, “film”, “layer”, “upper layer”, “coating layer”, or the like. Although in the subsequent patent claims only the term “substrate” will be used, it should not be construed as limiting the scope of the invention and may cover such terms as “undercoat”, “film”, “layer”, “under-layer”, or the like.

Although the coatings on substrates suitable for testing by the method and apparatus of the invention may have different thickness, the invention may be most advantageous for testing and measuring characteristics of thin and ultra-thin coatings, e.g., of those having thickness within the range from nanometers to tens of nanometers.

### BRIEF DESCRIPTION OF THE DRAWINGS

FIG. 1 is a general schematic view of a tester of the invention suitable for realization of the method of the invention.

FIG. 2 is a sectional view of an indenter holder with a conductive prism-like indenter.

FIG. 3 is a sectional view of an indenter holder with a conductive ball-like indenter.

FIG. 4 is an example of a graph illustrating increase in electrical resistance R during a scratch test of a conductive coating on a non-conductive substrate.

FIG. 5 is an example of a graph illustrating decrease in electrical resistance R during a scratch test of a non-conductive coating on a conductive substrate.

FIG. 6 is an example of a graph illustrating variation in electrical resistance R during a scratch test of an ultra-thin non-continuous non-conductive coating on a conductive substrate.

FIG. 7 is a schematic view of a scratch test of the object 40 with the prismatic indenter 30a during unidirectional linear motion of the indenter 30a.

FIG. 8 is a schematic view of a wear test of the object 40 with the spherical indenter 30b during reciprocating linear motion of the indenter 30b.

FIGS. 9a-9c are graphs illustrating various stages of the scratch test of the Sample #1: FIG. 9a—at 200 g (2N) the coating was not cut and ESR remained low, FIG. 9b—at 350 g (3.5 N) the coating started to break and ESR increased slightly, FIG. 9c—at 400 g (4 N) the coating was broken and ESR increased, but not completely cut though and ESR did not reach its maximum level.

FIGS. 10a-10c are graphs illustrating various stages of the scratch test of the Sample #2: FIG. 10a—at 100 g (1 N) the coating was not cut and ESR remained low, FIG. 10b—at 200 g (2 N) the coating started to break and ESR increased slightly, FIG. 10c—at 300 g (3 N) the coating was broken and ESR increased, but not completely cut though and ESR did not reach its maximum level.

FIGS. 11a-11c are graphs illustrating various stages of the scratch test of the Sample #3: FIG. 11a—at 150 g (1.5 N) the coating started to break and ESR increased slightly, FIG. 11b—at 200 g (2 N) the coating was broken but not completely, and ESR increased, but did not reach its maximum level, FIG. 11c—at 300 g (3 N) the coating was completely cut through and ESR jumped to its maximum level of 1 MOhm.

### DETAILED DESCRIPTION OF THE INVENTION

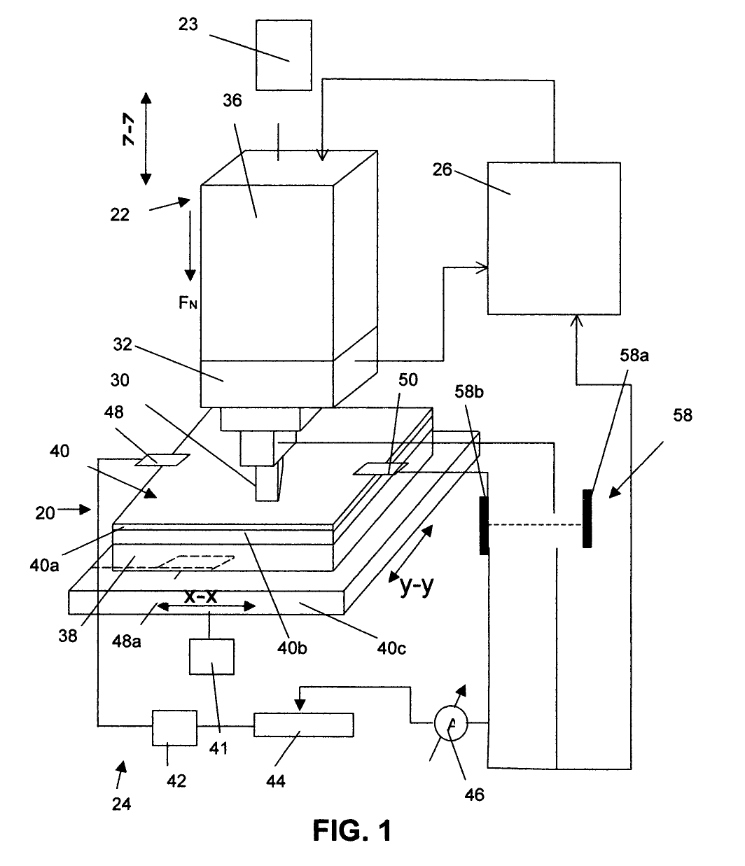

FIGS. 1-3—Description of the Tester for Determining Characteristics of Thin Films and Coatings on Substrates

A general schematic view of a tester of the invention suitable for realization of the method of the invention is shown in FIG. 1. The tester consists of an actuating unit 20, a loading and measuring unit 22 (e.g., both from a commercial tester mod. UMT-2 produced by Center for Tribology, Inc., Campbell, Calif.), a measurement electrical circuit 24, and a control unit 26.

The actuating unit 20 is a part of a commercially produced tester for scratch, adhesion, wear, fatigue and hardness measurements of coatings. It can provide a combination of rotational and linear motions to the specimen and indenter, in both vertical and horizontal directions. The loading and measuring unit 22 is a part of the same commercial tester, which simultaneously measures an applied vertical force, friction force, wear or indentation depth, and contact acoustic emission. Since the tester of Model UMT-2 is a commercially produced device, detailed description of its actuating, loading and measuring units and their operation is omitted and can be found in U.S. Pat. No. 5,795,990 issued in 1998, U.S. Pat. No. 6,363,798 issued in 2002, and U.S. Pat. No. 6,418,776 issued in 2002, all these patents owned by the applicant of the present application.

In FIG. 1, the loading and measuring unit 22 is shown schematically and comprises a loading unit 36 that supports an indenter 30 (e.g., of the type described in U.S. Pat. No. 6,502,455) via a force sensor 32 connected to an indenter holder 34. The unit 22, and, hence, the scratching indenter 30, can perform vertical linear movements in the direction of Z-Z axis (FIG. 1). For versatility of the tester, the unit 22 can have a carriage (not shown) that can perform reciprocating movements in the X-X or Y-Y direction, or an upper spindle (not shown) that can be driven into rotation around its vertical axis by a motor 23.

Reference numeral 38 designates a moving table that rigidly supports an object 40 to be tested and performs linear movement in the direction of Y-Y axis (FIG. 1). For versatility of the tester, the table 38 can be turned (not shown) to provide movement in the direction of X-X axis and can be rotated by a motor 41 around its vertical axis. Thus, some tests can be carried out with movements of the indenter 30 relative to the stationary object 40, while other tests can be carried out with movements of the object 40 relative to the indenter 30. Except for a few examples thereafter, the description will relate to the case of the table 38 linearly moving in the direction of axis Y-Y and fed in the direction of axis X-X, while the indenter 30 moving in the direction of Z-Z axis.

The object 40 may comprise a thin film, coating or a layer 40a on a substrate or undercoat or under-layer 40b. For example, the object 40 may comprise a hard magnetic disk consisting of an ultra-thin layer of diamond-like carbon (DLC) on a thin composite magnetic layer sputtered on a NiP under-layer, which, in turn, is plated on an aluminum or glass-ceramic substrate. In the first embodiment, the object 40 is selected for determining characteristics of the conductive magnetic layer 40a on the NiP under-layer 40b. In the second embodiment, the object 40 is selected for determining characteristics of the non-conductive (in actuality, less conductive) DLC coating 40a on the magnetic layer 40b.

Although the object shown in FIG. 1 is described as a specific multilayered structure with all layers being conductive or semi-conductive but having different conductivities, it is understood that this structure is given only as an example and that other structural combinations of coatings or films and substrates or under-layers are possible, provided that the substrates and the coatings have different electrical characteristics. For example, the object 40 may comprise a conductive thin aluminum film 40a on a non-conductive silicon oxide substrate 40b of a semiconductor silicon wafer (MOS structure).

The measurement electric circuit 24 consists of a source of electric power 42 connected in series with a variable resistor 44, a measurement instrument 46, e.g., an ammeter, and two electrical contacts 48 and 50. The measurement instrument 46 may be also a voltage-meter, capacitance-meter, resistance-meter, or an impedance-meter.

The control unit 26 is connected to both the actuating unit 20, for setting the motions and speeds of the table 38, and the loading and measuring unit 22 for setting the force applied by the loading unit 36 to the surface of the object 40 via the indenter 30. The actual force acting in the direction of Z-Z axis is measured by means of the sensor 32, connected to the unit 26. Also, the unit 26 can control the results of measurements obtained on the ammeter 46.

In the first embodiment of this invention, during the test, the electrical circuit is closed through the conductive layer 40a, electrically connected to both the first electrical contact 48 and second electrical contact 50.

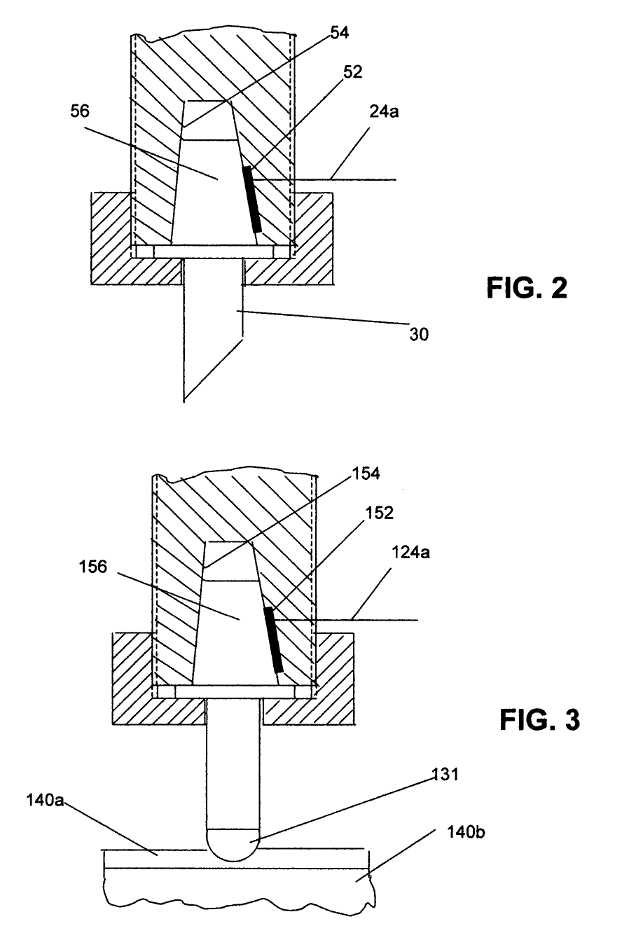

In the second embodiment, the first contact 48 is electrically connected not to the coating or film being tested, but to the conductive substrate. The position of the contact 48 for testing non-conductive films is shown in FIG. 1 by reference number 48a. The measurement electric circuit 24 is provided with a branched line 24a, shown in FIG. 2 (which is a sectional view of the indenter holder 34), connecting the power source 42 via the adjustable resistor 44 and the ammeter 46 to an electrical contact 52. The electrical contact 52 is built into the holder 34 so that its contact surface is exposed to the inner surface of the holder's central opening 54 that accommodates a tail portion 56 of the indenter 30, so that the contact 52 could have an electrical contact with the conductive indenter 30 which in this case is included into the electrical circuit. For testing characteristics of non-conductive coatings, the indenter 30 must be conductive. The branched line includes an electric switch 58 with a pair of interlocked switching contacts 58a and 58b (see FIG. 1). The switching contact 58a is located in the branched line 24a, while the switching contact 58b is located in the main line of the circuit 24 that connects the power source 42 with the electrical contact 50 (see FIG. 1).

The example described above with reference to FIGS. 1 and 2 relates to the case of measurement with the use of power supply from the source 42, which in this case is a D.C. power source. However, the same tester and the principle of the invention may be realized also with an A.C. power supply source 42. In the case of a non-conductive coating or film 40a on a conductive substrate 40b, the measured value will comprise an alternating current signal, which will grow with an increase in capacity developed between the measured coating or film 40a and the substrate 40b, since with approach to the contact between the indenter and the substrate the electrical resistance decreases. When at the moment of contact the capacity approaches infinity, the electrical resistance between the indenter 30 and the substrate 40b approaches zero.

When in the embodiment of the A.C. power source 42 (FIG. 1) the test object 40 is a conductive coating or film 40b on a non-conductive substrate 40b, the electrical resistance will increases with approach of the indenter 30 towards the substrate 40b, and at the moment of contact between the tip of the indenter 30 and the non-conductive substrate, a certain capacitance C will instantly appear in the measurement circuit 24. In this case, the measurement signal (A.C. current signal) will depend on the aforementioned capacitance.

Instead of a prismatic tip shown in FIGS. 1 and 2, the indenter may have a spherical tip 131, as shown in FIG. 3, with the same shape of the tail portion 156 for insertion into a holder 154 as the prismatic indenter. The rest of the apparatus is the same as described above. The indenter with the spherical tip 131 may be more appropriate for testing softer coatings, for which the sharp prismatic indenter is not acceptable.

FIGS. 1-3—Operation of the Tester of the Invention for Determining Characteristics of Thin Films and Coatings on Substrates

Let us first select the object 40 with a conductive film 40a, e.g., a copper film, on a non-conductive substrate 40b, e.g., a silicone-oxide wafer. The object is rigidly fixed on the moving table 38. Both electrical contacts 48 and 50 are connected to the conductive film 40a. The electrical switch 58 is installed in a position that opens the contacts 58a and closes the contacts 58b to provide flow of electrical current through the coating layer 40a. The power source 42 of the electrical circuit 24 is energized.

The loading unit 36 is moved towards the object 40 until the tip of the indenter 30 comes into physical contact with the surface of the coating or film 40a of the object 40. The loading unit 36 is then accurately moved relative to the object until the actual force Fz measured by the sensor 32 reaches a value preset by the control unit 26. The movable table 38 begins reciprocate linearly, thus moving the object 40 in the direction of Y-Y axis relative to the indenter 30, that scratches the film 40a, while the applied force is maintained at a constant level.

In each reciprocation cycle, the electrical measurement circuit 24 measures electrical current, which inversely proportional to electrical resistance between the contracts 48 and 50. The results of measurement are shown in the ammeter 46 and recorded in real time via the control unit 26.

With each subsequent stroke of the table 38 in the direction of Y-Y axis, the loading unit 22 is raised and is then descended with a force discretely and controllably increased by the loading unit 22 via the control unit 26. With each stroke, the table is also shifted in the direction of X-X axis in order to expose a new non-destructed area of the coating film 40a to the indenter 30; the feed in the direction of X-X axis is also controlled from the control unit 26.

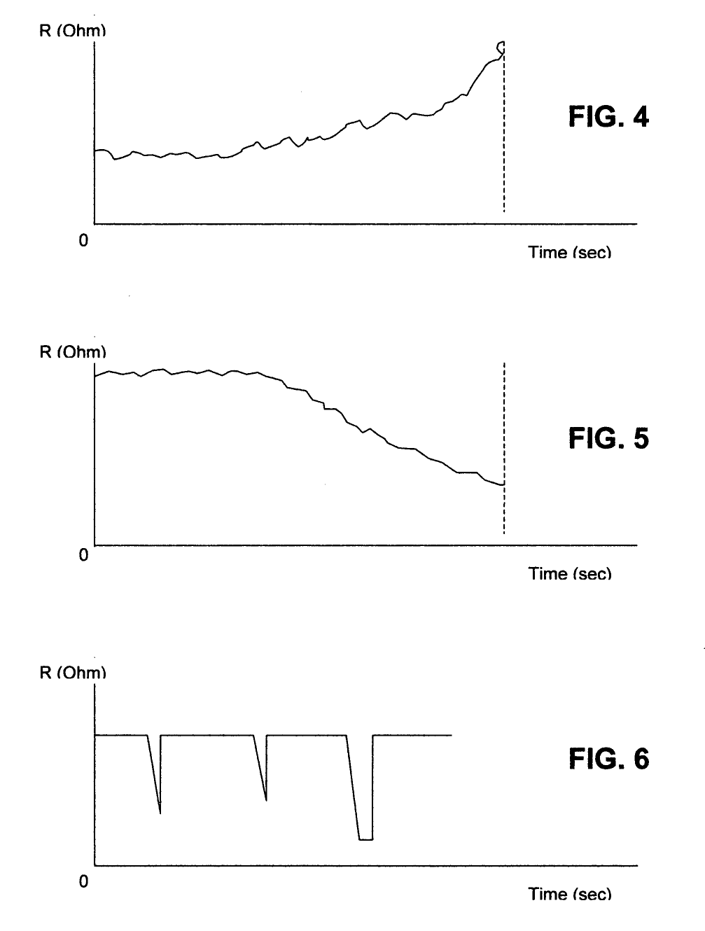

With increase in force, the indenter 30 penetrates deeper into the coating 40a and removes more material from this coating. At the moment when the conductive coating 40a is completely removed, the portion of the electrical circuit 24 between the contacts 48 and 50 is interrupted, and the electrical resistance sharply increases. An example of this test is shown in the graph of FIG. 4 that illustrates an increase in electrical resistance R (ordinate axis) versus time (abscissa axis), though a number of reciprocating cycles, cumulative stroke distance, or applied force can also be plotted on the abscissa axis.

The reciprocating motion in the above example can be easily substituted by a uni-directional motion, either rotational or linear, with similar test procedure and results. Also, a combination of two or several motions can be performed on the apparatus shown in FIG. 1.

The description given above is applicable for both the prismatic indenter 30 of FIG. 2 and the spherical indenter 131 of FIG. 3.

Also, the predetermined applied force can be maintained constant during the test, with no movement of the table between the cycles (thus indenting and scratching the coating repeatedly in the same area), so that the measured characteristics will be reflective of fatigue characteristics of the coating under repeated stress.

The same method and apparatus can be used when selecting the object 40 with a non-conductive film 40a, e.g., a polymer layer, on a conductive substrate 40b, e.g., a magnetic under-layer of a hard disk. The object 40 is rigidly fixed on the moving table 38. The first electrical contact 48 is connected to the conductive under-layer, or substrate 40b, the contact 58a is closed, the contract 58b of the electrical switch 58 is open, so that the electrical circuit 24 remains open until the non-conductive layer 40a is completely removed, and the conductive indenter 30 (FIG. 1 and FIG. 2) comes into electrical contact with the conductive substrate 40b. All operations of loading, measuring and recording the force, electrical resistance, etc., are carried out in the same manner as described above.

With the increase in force, the indenter 30 penetrates deeper into the coating layer 40a and removes more material from this layer. At the moment when the non-conductive coating 40a is completely removed, the electrical circuit 24 between the contacts 48 and 50 closes, and the electrical resistance sharply drops. An example of this test is shown in the graph of FIG. 5 that illustrates a drop in electrical resistance R (ordinate axis) versus time (abscissa axis), though a number of reciprocating cycles or cumulative stroke distance or applied force can be chosen on the abscissa axis, too.

Sometimes the object 40 is selected with the film 40a (see FIG. 1) that may have either non-uniform adhesion to the substrate (e.g., due to contamination in the coating-substrate interface) or non-uniform structure (e.g., some ultra-thin films). In this case, the characteristics of the non-conductive coatings or films are represented by a graph of the type shown in FIG. 6, where the abscissa and ordinate axes are the same as in FIGS. 4 and 5. Deep recesses on the curve correspond to moments when the conductive indenter 30 comes into electrical contact with the conductive substrate 40b. The area of the aforementioned recesses is a characteristic of the non-conductive coating, e.g., its adhesion to the substrate: the greater this area is, the lower is the interface adhesion strength. The sum of the areas of the recesses can be calculated by integration and processed in the control unit 26 for quantitative evaluation of appropriate characteristics. Computing an integral of deviations of the resistance or another electrical characteristic from its predetermined level, for example its normal level before scratching and indenting, over time or distance or force or number of cycles, and comparing this integral with its either critical or normal value, allow for repeatable and reproducible evaluation of the coating durability.

### EXAMPLE

### Scratch-Adhesion and Wear Tests of LCD Samples

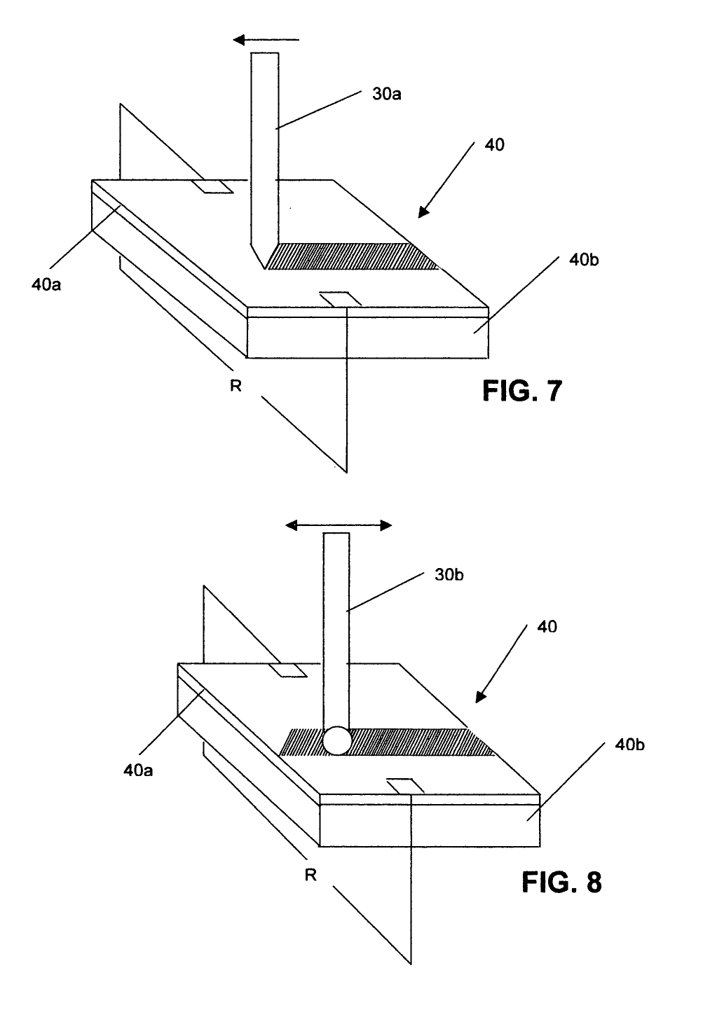

The tests were carried on objects 40 comprising liquid crystal display (LCD) samples. The LCD samples had an ultra-thin conductive coating of 10-nm thickness on a con-conductive polymer under-layer; three types of coatings (of the same material but deposited with three different processes) have been tested (samples #1 to #3). Each LCD sample was cut into 10×50 mm test specimens and clamped between the electrical contacts 48 and 50 (FIG. 1). A constant force was applied from the loading unit 36 via a closed-loop feedback servo control from the control unit 26. Two series of tests were performed, scratch tests as shown in FIG. 7 and wear tests as shown in FIG. 8.

In the scratch tests, the indenter 30a was a standard Rockwell-C diamond indenter making unidirectional linear motion as illustrated in FIG. 7. A series of runs with progressively increasing force, though constant within each run, was performed in each test. The force started from 1 N in the 1 st run and was increased by 0.5 N each run until the coating 40a was cut through and the electrical circuit 24 (see FIG. 1) was interrupted. Two parameters were continuously monitored and recorded: applied vertical force Fz and electrical surface resistance ESR.

The critical load characterizing the coating scratch resistance was defined as the minimum load to cut through the coating completely. The results for three different LCD samples, each tested three times, are given in Table 1 that shows repeatable differences between the coatings 40a.

TABLE 1
Scratch Test Results

| | Critical Load, N | | |
|---|---|---|---|
| Sample ID | 1^{st} Test | 2^{nd} Test | 3^{rd} Test |
| # 1 | 5 | 5.5 | 5.5 |
| # 2 | 4 | 4 | 4 |
| # 3 | 2.5 | 3 | 2.5 |

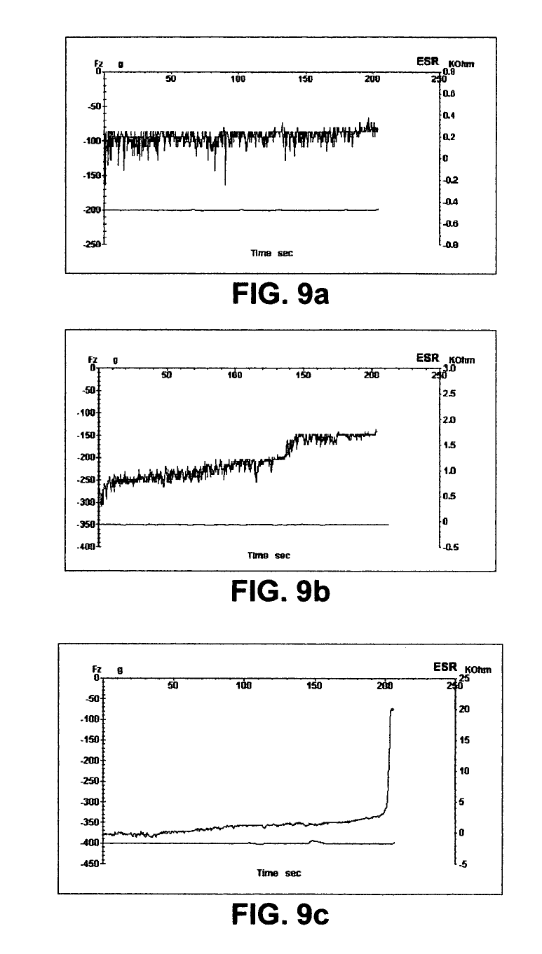

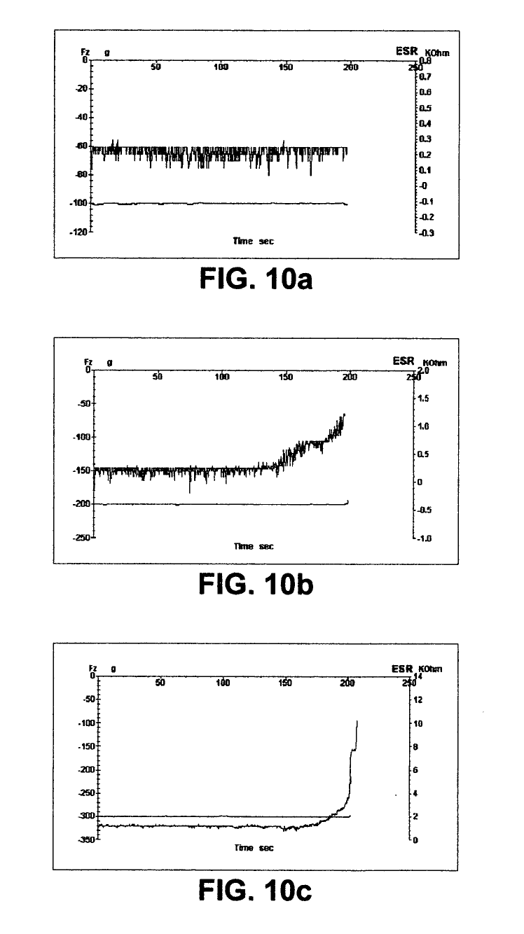

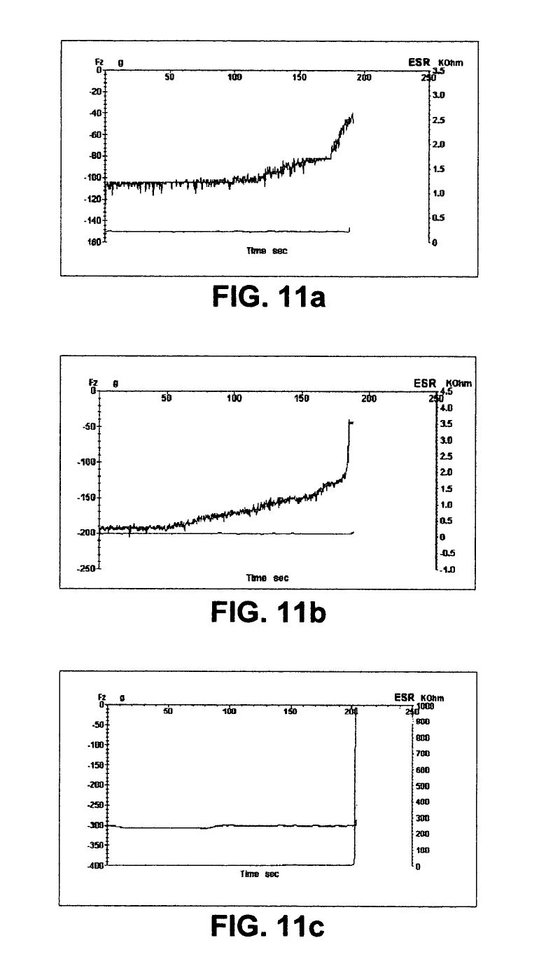

The typical scratch raw data is presented in FIGS. 9a-9c (for sample #1), FIGS. 10a-10c (for sample #2), and FIGS. 11a-11c (for sample #3), illustrating various stages of the process of cutting through the coatings 40a with the force increase. In these graphs, the abscissa axis and one of the ordinate axes are the same as in FIG. 4, the other ordinate axes show the applied force.

FIG. 9a illustrates the scratch test of sample #1 at the force of 2N: the electrical resistance remained low, which indicated that the coating was not cut. FIG. 9b illustrates the scratch test of sample #1 at the force of 3.5N: the electrical resistance slightly increased reflecting the fact that the coating started to break. FIG. 9c illustrates the scratch test of sample #1 at the force of 4N: the coating was broken, but not totally cut through; the electrical resistance increased, but did not reach its maximum level.

FIG. 10a illustrates the scratch test of sample #2 at the force of 1 N: the electrical resistance remained low, which indicated that the coating was not cut. FIG. 10b illustrates the scratch test of sample #2 at the force of 2N: the electrical resistance slightly increased reflecting the fact that the coating started to break. FIG. 10c illustrates the scratch test of sample #2 at the force of 3N: the coating was broken, the electrical resistance increased, but did not reach its maximum level, which is reflective of the fact that the coating was broken, but not totally cut through.

FIG. 11a illustrates the case of the scratch test of sample #3 at the force of 1.5N: the coating started to break, but not totally cut through. FIG. 9b illustrates the scratch test of sample #3 at the force of 2N: the coating was broken, but not totally cut through. FIG. 9c illustrates the scratch test of sample #3 at the force of 3N: the coating was totally cut through, the electrical resistance jumped to its maximum level of 1 MOhm.

The wear tests, schematically shown in FIG. 8, were carried out with the use of a spherical indenter 30b, performing reciprocating linear motions causing coating wear. A constant force of 1 N was chosen, under which there was no complete failure for all samples in the above-described scratch tests. A series of reciprocating cycles was run until the coating 40a was worn through. The critical number of cycles, characterizing the coating wear resistance, was defined as the minimum number of cycles to wear through the coating completely.

The results of the wear tests of the three LCD samples are summarized in Table 2. They show the repeatable differences between the coatings, well correlated with the scratch data. Indeed, in both the scratch and wear, tests sample # 1 had the highest durability and sample #3 had the lowest durability.

TABLE 2
Wear Test Results

| | Critical # Cycles, thousands | | |
|---|---|---|---|
| Sample ID | 4^{th} Test | 5^{th} Test | 6^{th} Test |
| # 1 | 2.7 | 2.5 | 2.6 |
| # 2 | 2.1 | 2.2 | 2.0 |
| # 3 | 1.1 | 1.2 | 1.1 |

Thus, the novel test method and apparatus of the present application allow for accurate and repeatable quantitative evaluation of scratch, adhesion and wear of LCD and other ultra-thin films and coatings.

Thus, it has been shown that the invention provides a very powerful and fast method and apparatus for reliable testing and measurement of characteristics in ultra-thin films and coatings. The aforementioned method and apparatus allow for reliable interpretation of test and measurement data and are suitable for measuring characteristics of films and coating having a thickness of the order from nanometers to microns. The apparatus of the invention is universal as it is suitable for measuring characteristics of both conductive and non-conductive coatings.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, in the embodiments with an A.C. power source, the test can be carried out on different frequencies with modulation and synchronous detection of signals. The test materials may be different from those mentioned in the description. The combination of the coatings and substrate may include both the coatings and substrates from conductive materials, but with substantially and measurably different conductivities. The electrical measuring instrument is shown as an ammeter only as an example and may comprise a digital indicator with digital processing of the measured data. Objects suitable for testing by the method and apparatus of the invention may be different from those described in the present application and may comprise various multi-layered composite materials and structures. For testing characteristics of non-conductive coatings on conductive substrates, the first electrical contact may be pierced through the non-conductive coating for establishing electrical contact with the conductive substrate.

1. A method for determining characteristics of a coating on a substrate that form an object, said method comprising:
providing an apparatus comprising:
means for supporting said object,
an indenter for interacting with said object,
a loading unit for applying a force between said object and said indenter,
means for providing a relative movement between said object and said indenter,
means for forming an electrical circuit comprising a source of electrical power, a first electrical contact, and a second electrical contact, and
means for measuring electrical characteristics of said electrical circuit;
selecting said object from a combination of a conductive coating with a non-conductive substrate and a non-conductive coating with a conductive substrate;
connecting said first contact to said conductive coating when said object comprises said combination of a conductive coating with a non-conductive substrate and to said conductive substrate when said object comprises said combination of a non-conductive coating with a conductive substrate;
connecting said second contact to a component selected from the group consisting of said conductive coating and said indenter, said conductive coating being selected if said object comprises said combination of a conductive coating with a non-conductive substrate, and said indenter being selected if said object comprises said combination of a non-conductive coating with a conductive substrate; at least a part of said indenter that interacts with said non-conductive coating being conductive if said indenter is selected;
causing said relative movement between said object and said indenter;
applying a predetermined force between said indenter and said coating by said loading unit;
measuring said electrical characteristics of said electrical circuit; and
determining said characteristics of said coating by analyzing said electrical characteristics of said electrical circuit.

2. The method of claim 1, wherein said predetermined force is selected from a constant force and an increasing force.

3. The method of claim 1, wherein said relative movement is selected from the group consisting of a linear unidirectional motion, linear reciprocating motion, rotary unidirectional motion, and rotary reciprocating motion.

4. The method of claim 1, wherein said means for providing a relative movement provides two relative movements selected from the group consisting of a linear unidirectional movement, linear reciprocating movement, rotary unidirectional movement, and rotary reciprocating movement.

5. The method of claim 2, wherein said relative movement is selected from the group consisting of a linear unidirectional motion, linear reciprocating motion, rotary unidirectional motion, and rotary reciprocating motion.

6. The method of claim 2, wherein said means for providing a relative movement provides two relative movements selected from the group consisting of a linear unidirectional movement, linear reciprocating movement, rotary unidirectional movement, and rotary reciprocating movement.

7. The method of claim 1, wherein said electrical characteristics measured by said means for measuring electrical characteristics of said electrical circuit are selected from the group consisting of electrical current, electrical voltage, electrical resistance, electrical conductivity, electrical capacitance, and electrical impedance.

8. The method of claim 2, wherein said electrical characteristics measured by said means for measuring electrical characteristics of said electrical circuit are selected from the group consisting of electrical current, electrical voltage, electrical resistance, electrical conductivity, electrical capacitance, and electrical impedance.

9. The method of claim 3, wherein said electrical characteristics measured by said means for measuring electrical characteristics of said electrical circuit are selected from the group consisting of electrical current, electrical voltage, electrical resistance, electrical conductivity, electrical capacitance, and electrical impedance.

10. The method of claim 4, wherein said electrical characteristics measured by said means for measuring electrical characteristics of said electrical circuit are selected from the group consisting of electrical current, electrical voltage, electrical resistance, electrical conductivity, electrical capacitance, and electrical impedance.

11. The method of claim 1, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

12. The method of claim 2, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

13. The method of claim 3, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

14. The method of claim 4, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

15. The method of claim 5, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

16. The method of claim 6, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

17. The method of claim 7, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

18. The method of claim 8, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

19. The method of claim 9, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

20. The method of claim 10, wherein said step of determining said characteristics of said coating by analyzing said electrical characteristics of said electrical circuit comprises detecting a moment when said electrical characteristics change, wherein said change is an increase of said characteristics above a predetermined value for said object that comprises said combination of a conductive coating and a non-conductive substrate, and said change is a decrease of said characteristics below a predetermined value for said object that comprises said combination of a non-conductive coating and a conductive substrate.

21. The method of claim 1, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

22. The method of claim 7, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

23. The method of claim 8, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

24. The method of claim 9, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

25. The method of claim 10, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

26. The method of claim 11, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

27. The method of claim 12, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

28. The method of claim 13, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

29. The method of claim 14, wherein said analyzing said electrical characteristics of said electrical circuit comprises the steps of:
computing an integral of deviations of said electrical characteristics of said electrical circuit from a predetermined level of said electrical characteristics over a parameter selected from the group consisting of time, distance, force, and a number of cycles; and
comparing said integral with a predetermined value.

30. An apparatus for determining characteristics of a coating on a substrate that form an object, said apparatus comprising:
means for supporting said object,
an indenter for interacting with said object,
a loading unit for applying a force between said object and said indenter,
means for providing a relative movement between said object and said indenter,
means for forming an electrical circuit comprising a source of electrical power, a first electrical contact, and a second electrical contact,
means for measuring electrical characteristics of said electrical circuit, and
means for selectively connecting said first contact to said coating when said object comprises a conductive coating and a non-conductive substrate and to said substrate when said object comprises a non-conductive coating and a conductive substrate, and for selectively connecting said second contact to said conductive coating when said object comprises said conductive coating and said non-conductive substrate and to said indenter when said object comprises said non-conductive coating and said conductive substrate; at least a part of said indenter that interacts with said non-conductive coating being conductive if said indenter is selected.

31. The apparatus of claim 30, wherein said means for providing a relative movement is selected from the group consisting of a linear unidirectional motion means, linear reciprocating motion means, rotary unidirectional motion means, and rotary reciprocating motion means.

32. The method of claim 31, wherein said means for providing a relative movement consists of two motion means selected from the group consisting of a linear unidirectional motion means, linear reciprocating motion means, rotary unidirectional motion means, and rotary reciprocating motion means.

33. The apparatus of claim 30, wherein said first contact and said second contact are a pair of interlocked contacts arranged so that said second contact is open when said first contact is closed, and said second contact is closed when said first contact is open.

34. The apparatus of claim 31, wherein said first contact and said second contact are a pair of interlocked contacts arranged so that said second contact is open when said first contact is closed, and said second contact is closed when said first contact is open.
